(19) United States
(12) Patent Application Publication
(10) Pub. No.: US 2002/0181379 A1
(43) Pub. Date: Dec. 5, 2002

(54) Disk cartridge with dust collection

(76) Inventor: Coen J. Warmenhoven, Colorado Springs, CO (US)

Correspondence Address: Oppenheimer Wolff & Donnelly LLP, Suite 3300, 45 South Seventh Street, Minneapolis, MN, 55402-1609, US

(21) Appl. No.: 09/839,344

(22) Filed: Apr. 20, 2001

(51) Int. Cl. G11B 3/58; G11B 3/70; G11B 5/84; G11B 7/26

(52) U.S. Cl. 369/72; 369/291

(57) ABSTRACT

A disk cartridge with dust collection is disclosed. The disk cartridge includes a cartridge shell with a door assembly. Inside the disk cartridge is an optical, magnetic, or other type of disk which rotates and can be read from or written to by the access device. The cartridge shell is manufactured with interior recessed areas into which dust collection element can be placed. In some embodiments, the recessed areas are positioned so that the surface of the disk moves proximately to the recessed areas as the disk rotates. In some other embodiments, the recessed areas are positioned near a corner (or other region) of the cartridge shell. The dust collection element can be double-sided sticky tape, grease, electrostatic material, or other composition which can attract and retain airborne dust particles.

### BACKGROUND OF THE INVENTION

The present invention relates to disks for disk drives, and more particularly to a system for minimizing contamination of such disks.

Since the launch in 1982 of the audio CD, optical disks have become a very popular storage media due to their durability, random access features, and data capacity. However, portions of an optical disk can become unreadable when the disk is scratched or becomes dirty. To minimize the disk's contact with airborne dust particles, optical disks are now often enclosed in a disk cartridge. When the disk is inserted in a disk drive, the disk cartridge's door assembly is opened so that the disk drive can access the disk itself. While the door assembly is open, dust particles can enter the disk cartridge and settle on the disk, causing problems.

The computerization of businesses has steadily increased the amount of data that is processed. As more data is processed, the amount of data which must be stored increases as well. To meet the need of this ever increasing amount of data, cost-effective data storage is desired. Optical recording is especially attractive due to the high capacities that can be achieved on a single removable disk. However, to remain competitive and to meet the needs for storage, increasing the disk capacity is a paramount development goal for optical drive products. (P. Asthana, B. I. Finkelstein , and A. A. Fennema, “Rewritable optical disk drive technology,” IBM Journal of Research and Development, Vol. 40, No. 5 (1996))

One method of increasing an optical disk's capacity is by using a stronger object lens. However, a stronger lens must be placed closer to the optical media. Dust becomes a more pressing problem in these situations.

What is needed is an improved disk cartridge with a dust collection component which would decrease the amount of dust which settles on the disk after entering the cartridge. By reducing dust, the performance of the disk would be improved.

### BRIEF SUMMARY OF THE INVENTION

This invention can be regarded as a disk cartridge with dust collection capabilities. The disk cartridge includes a cartridge shell with a door assembly. Inside the disk cartridge is an optical, magnetic, or other type of disk which rotates. While rotating, an access device can read from or write to the disk. The cartridge shell is manufactured with interior recessed areas into which a dust collection element can be placed. In some embodiments, the recessed areas are positioned so that the surface of the disk moves proximately to the recessed areas as the disk rotates. In other embodiments, the recessed areas are positioned near one or more corners of the interior of the cartridge shell. As the disk rotates, air flow is created within the cartridge. This airflow causes movement of the dust particles, which are collected and by the dust collection element. The dust collection element can be double-sided sticky tape, grease, electrostatic material, or other composition.

### BRIEF DESCRIPTION OF THE DRAWINGS

FIG. 1 is a simplified side view of a disk and access device, where the disk has a relatively thick substrate.

FIG. 2 is a simplified side view of a disk and access device, where the disk has a relatively thin cover layer.

FIG. 3 is a top view of a disk cartridge with a door assembly.

FIG. 4 is a top perspective view of a lower half of a disk cartridge, showing a series of recessed areas.

FIG. 5 provides a cross-sectional view of a disk in a disk cartridge.

FIG. 6 is a top view of a lower half of a disk cartridge, showing a recessed he corner of the cartridge.

### DETAILED DESCRIPTION OF THE INVENTION

The present invention is a disk cartridge with dust collection capability. Throughout the drawings, an attempt has been made to label corresponding elements with the same reference numbers. The reference numbers include:

| Reference | |
|---|---|
| Number | Description |
| 105 | disk |
| 110 | active layer |
| 115 | substrate |
| 120 | lens |
| 125 | beam |
| 130 | laser spot |
| 135 | dust particle |
| 140 | cover layer |
| 145 | disk cartridge |
| 150 | door assembly |
| 160 | recessed area |
| 165 | dust collection element |
| 170 | cartridge shell |
| 175 | hub |
| 180 | upper half of cartridge shell |
| 185 | lower half of cartridge shell |

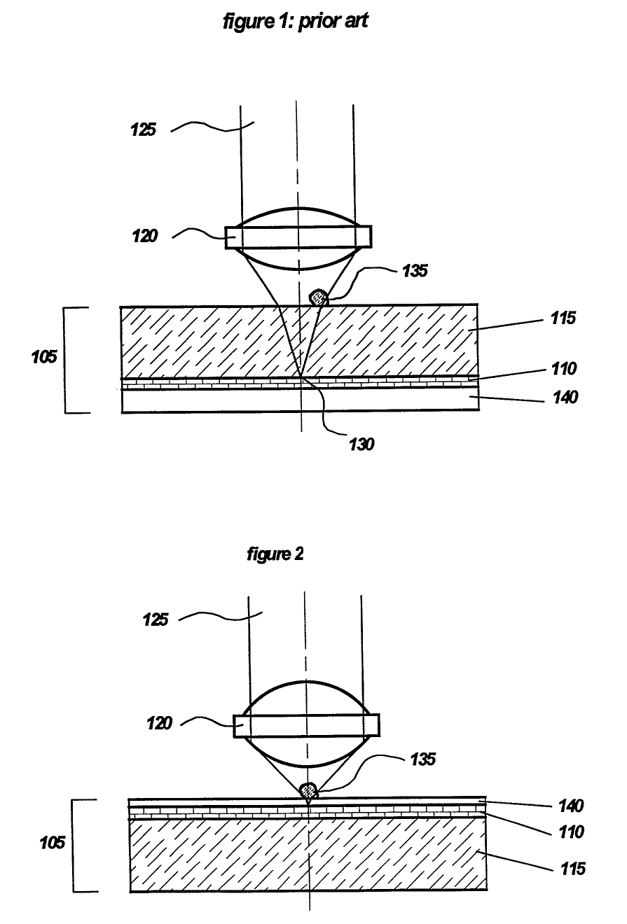

Referring to the drawings, FIGS. 1 and 2 illustrate the problems created by dust within a disk system. Specifically, FIG. 1 shows a cut-away side view of a disk 105 from the prior art, having a substrate 115, an active layer 110 and a cover layer 140. In FIG. 1, the substrate is on top, as commonly used in today's CD and DVD products.

The disk 105 can be any type of optical disk, such as an audio CD, a CD-ROM, DVD, DVD-ROM, DVD-RAM, DVD-RW, MO, or a WORM disk. The substrate 115 is commonly a polycarbonate plastic. In the optical disk industry, the plastic portion of the substrate 115 can be “pre-recorded” by being stamped with millions of pits corresponding to the binary representation of the data or information stored on the disk. This could include computer data, audio tracks, digitalized video, etc. If not “pre-recorded,” the optical disk can be later written to with a laser writing head.

A thin layer of aluminum or other material is applied, coating the plastic substrate 115 and forming the active layer 110. Then a laquer (or similar material) is applied as the cover layer 140, which offers protection to the active layer 110. Usually the substrate 115 is a relatively thick—perhaps 1.2 mm for CD and MO-type of disks, and 0.6 mm for DVD-type of disks.

The substrate 115, active layer 110 and cover layer 140 can be made of other substances. In the CD-ROM and WORM industries, the substrate 115 can also be formed from PMMA or glass; the active layer 110 can be organic die instead of aluminum; and the cover layer 140 can be UV curing laquer as from D.S.M. or Dai Nippon, for example.

The disk 105 is often enclosed in a cartridge which protects the disk 105. The disk 105 is inserted into a disk drive, which has a drive motor and an access device. The drive motor rotates the disk and the access device is positionable with respect to the rotating disk. The access device includes components which direct a laser or other light beam 125 through a prism/lens assembly 120 to create a focused laser spot 130 on the disk 105 in order to write to or read from the disk.

Dust can accumulate on the disk 105. As explained below, this dust can have various effects on the disk system. FIG. 1 shows a dust particle 135 on the substrate 115 of the disk 105. In FIG. 1, the dust particle 135 blocks only a small portion of the focused laser beam and so the laser spot 130 is not completely affected.

As the computer industry grows there is a continuous need for increased data storage capacity. One way to achieve increased storage capacity on a disk 105 is to reduce the size of the laser spot 130 on the active layer 110. This can be accomplished by using a stronger lens 120. However, a stronger lens 120 needs to be closer to the active layer 110, requiring that the cover layer 115 be thinner. For example, a DVD may have a cover layer of only 0.6 mm.

In the future, cover layers may even be just 0.1 mm. FIG. 2 shows a possible example of a future standard of a DVR disk 105 with a thinner cover layer 115. Because future applications might have cover layers as thin as 0.1 mm, probably the substrate and the cover will be switched, as shown in FIG. 2.

With the thinner cover layer 140, dust particles 135 are more problematic because a dust particle 135 will interfere with a greater percentage of the focused laser beam 125. If enough of the laser beam 125 is hindered, the portion of the disk 105 beneath the dust particle 135 will not be accessible.

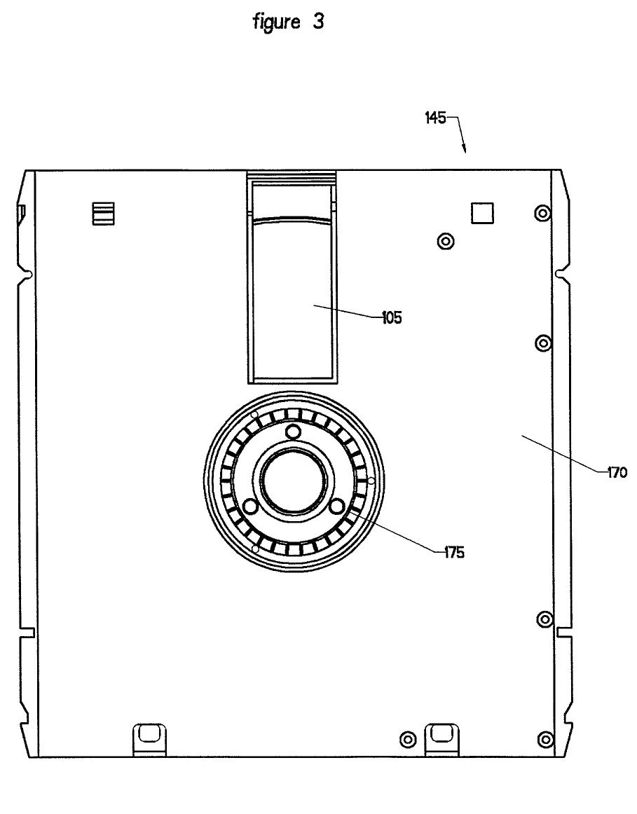

Because dust and debris affect disks, disks are usually used in a cartridge. FIG. 3 shows a disk 105 in a disk cartridge 145. The disk cartridge 145 includes a door assembly 150 (not shown) on a cartridge shell 170, which is opened in FIG. 3. The disk cartridge 145 also includes a hub 175 which allows the disk drive to spin the disk 105. In some embodiments, disk cartridges 145 are created by joining an upper half of a cartridge shell 180 to a lower half of a cartridge shell 185.

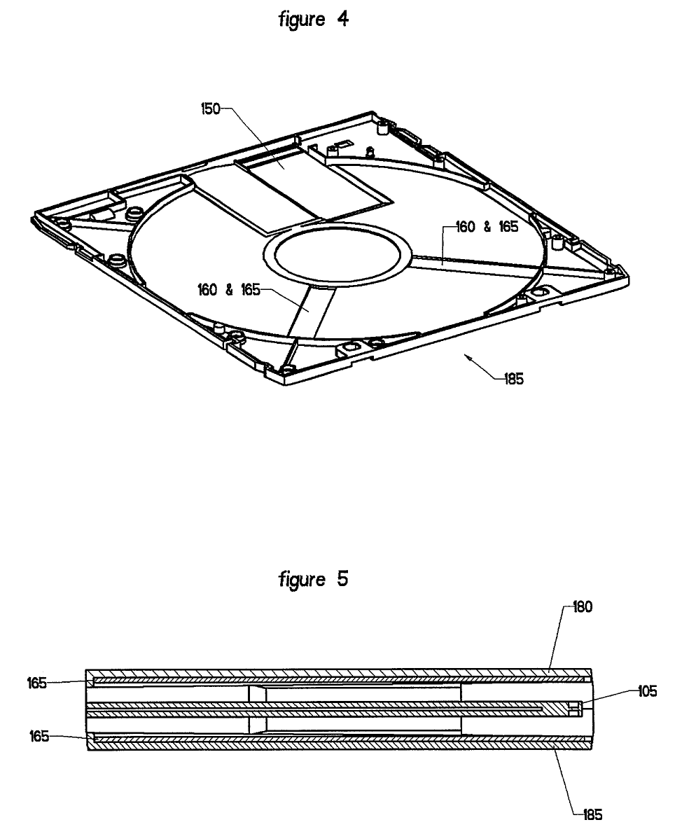

FIG. 4 shows one such lower half of a disk cartridge shell 185. The door assembly 150 allows a door to be opened and closed. Under the scope of the present invention, two recessed areas 160 have been created in the lower half of a disk cartridge shell 185. These recessed areas 160 are positioned so that the surface of the disk 105 (not shown) moves proximately to the recessed areas 160 as the disk 105 rotates. As the disk 105 rotates, air in the disk cartridge 145 moves through the interior of the cartridge shell 170. The whirling air creates airborne dust particles which have entered the disk cartridge 145 via the door assembly 150.

For the present invention, a dust collection element 165 is placed in the recessed areas 160. As dust particles whirl around in the air within the disk cartridge 145, the dust collection element 165 attracts and retains the dust particles so that the dust particles will not settle on the disk 105. The dust collection element 165 can be double-sided sticky tape, grease, or another substance with the proper adhesive or electrostatic qualities. The chemical composition of the dust collection element 165 should be thick enough so that it does not get displaced within or flow out of the cartridge, regardless of the cartridge's orientation or the existence of such environmental as high temperature, humidity or vibrations. Preferably, the dust collection element 165 should retain its ability to collect and retain dust over time. It should remain actively adhesive for several years, ideally for the expected life of the disk cartridge 105.

FIG. 5 shows a cutaway side view of the disk 105, recessed areas 160 and dust collection element 165 within the disk cartridge 145. As can be seen in FIG. 5, the dust collection element 165 can be placed closely above and below the disk 105. This positioning, in conjunction with the previously mentioned airflow, optimizes the collection of dust and keeps the disk surface relatively dust free.

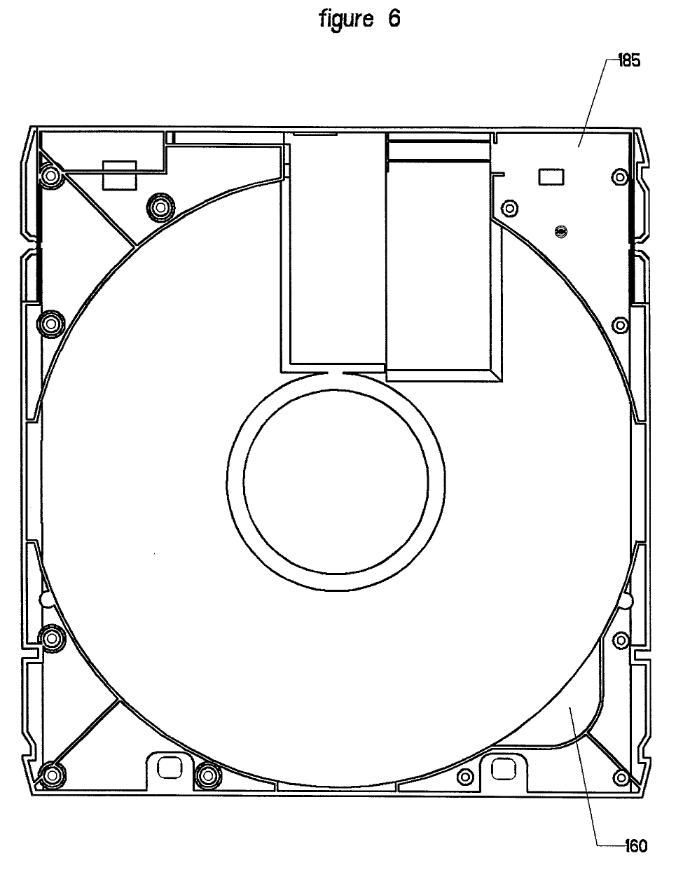

FIG. 6 shows another embodiment of the present invention. In FIG. 6, a lower half of a disk cartridge shell 185 is shown. However, in FIG. 6, a recessed area 160 is formed near a corner of the cartridge shell, into which the dust collection element 165 can be placed. Of course, one skilled in the art could create embodiments in which there are differing positions, sizes, and numbers of recessed areas 160 and dust collection elements 165.

Although a CD or other optical disk has been so far described, the use of recessed areas 160 holding dust collection element 165 is also applicable to other disk cartridges. For example, the disk 105 can also be a magnetic floppy diskette, such as the common 3.5 inch diskette used with personal computers.

From the foregoing detailed description, it will be evident that there are a number of changes, adaptations and modifications of the present invention which come within the province of those skilled in the art. However, it is intended that all such variations not departing from the spirit of the invention be considered as within the scope thereof.

What is claimed is:

1. A disk cartridge for protecting a disk, comprising:
a cartridge shell having an exterior surface and an interior surface, the interior surface having a recessed area;
a door assembly on the cartridge shell for allowing a disk to be accessed by an access device; and
dust collection element positioned in the recessed area of the cartridge shell, for collecting airborne dust.

2. The disk cartridge from claim 1, wherein the dust collection element is double-sided tape.

3. The disk cartridge from claim 1, wherein the dust collection element is grease.

4. The disk cartridge from claim 1, wherein the recessed area of the cartridge shell is positioned so that the surface of the disk moves proximately to the recessed area as the disk rotates.

5. The disk cartridge from claim 1, wherein the recessed area is positioned near a corner of the cartridge shell.

6. The disk cartridge from claim 1, wherein the dust collection element is material with electrostatic properties for attracting dust.

7. The disk cartridge from claim 1, wherein the dust collection element is a sticky material with that retains such sticky property for more than one year.

8. The disk cartridge from claim 1, wherein the dust collection element has a chemical composition with a viscous consistency so that the dust collection element remains placed within the recessed area.

9. A storage disk, comprising:
a disk for storing data;
a disk cartridge which encapsulates and protects the disk, the disk cartridge comprising a cartridge shell having an exterior surface and an interior surface, the interior surface having a recessed area; and
dust collection element positioned in the recessed area, for collecting dust particles so as to keep dust off of the disk.

10. The storage disk of claim 9, wherein the dust collection element is double-sided tape.

11. The storage disk of claim 9, wherein the dust collection element is grease.

12. The storage disk of claim 9, wherein the recessed area is positioned so that the surface of the disk moves proximately to the recessed area as the disk rotates.

13. The storage disk of claim 9, wherein the recessed area is positioned near a corner of the cartridge shell.

14. The storage disk of claim 9, wherein the dust collection element is material with electrostatic properties for attracting dust.

15. The storage disk of claim 9, wherein the dust collection element is a sticky material with that retains such sticky property for more than one year.

16. The storage disk of claim 9, wherein the dust collection element has a chemical composition with a viscous consistency so that the dust collection element remains placed within the recessed area.
